(19) United States
(12) Patent Application Publication
(10) Pub. No.: US 2024/0068436 A1
(43) Pub. Date: Feb. 29, 2024

(54) METHOD OF JOINING BLADE SEGMENTS USING AN INTERNAL BLADDER

(71) Applicant: General Electric Company, Schenectady, NY (US)

(72) Inventors: Peter Anthony BROOME, Park Ridge, IL (US); Allen Russel HALL, New Orleans, LA (US); Chad Allen BOUDOIN, New Orleans, LA (US)

(21) Appl. No.: 18/259,787

(22) PCT Filed: Dec. 23, 2021
(86) PCT No.: PCT/IB2021/062273

§ 371 Date: Jun. 29, 2023

(30) Foreign Application Priority Data
Dec. 30, 2020 (GB) 2020714.8

(51) Int. Cl. F03D 1/06; F03D 13/10

(52) U.S. Cl. CPC F03D 1/0658; F03D 13/108; F05B 2220/30; F05B 2230/604; F05B 2240/221

(57) ABSTRACT

A method for joining rotor blade segments of a rotor blade includes providing a first blade segment defining a concave cross-sectional shape having at least one internal flange. The method also includes providing a second blade segment having at least one external flange. Further, the method includes positioning the internal flange(s) of the blade segment internal of the external flange(s) of the second blade segment at a joint. Moreover, the method includes placing at least one inflatable internal bladder within an inner cavity of the rotor blade at the joint. In addition, the method includes inflating the internal bladder(s) so as to provide internal pressure thereto so as to align the internal flange(s) with the external flange(s) and to maintain contact between the internal flange(s) and the external flange(s). Thus, the method also includes securing the first and second blade segments together while maintaining the internal pressure via the internal bladder(s).

### FIELD

The present subject matter relates generally to wind turbines, and more particularly to segmented rotor blades for wind turbines and methods of joining same using one or more internal bladders.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known airfoil principles and transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The construction of a modern rotor blade generally includes skin or shell components, opposing spar caps, and one or more shear webs extending between the opposing spar caps. The skin is typically manufactured from layers of fiber composite and a lightweight core material and forms the exterior aerodynamic airfoil shape of the rotor blade. Further, the spar caps provide increased rotor blade strength by providing structural elements along the span of the rotor blade on both interior sides of the rotor blade. Moreover, spar caps are typically constructed from glass fiber reinforced composites, though spar caps for some larger blades may be constructed from carbon fiber reinforced composites. The shear web(s) generally include structural beam-like components that extend essentially perpendicular between the opposing spar caps and across the interior portion of the rotor blade between the outer skins.

The size, shape, and/or weight of rotor blades are factors that contribute to energy efficiencies of wind turbines. An increase in rotor blade size increases the energy production of a wind turbine, while a decrease in weight also furthers the efficiency of a wind turbine. Furthermore, as the size of wind turbines increases, particularly the size of the rotor blades, so do the respective costs of manufacturing, transporting, and assembly of the wind turbines. The economic benefits of increased wind turbine sizes must be weighed against these factors.

One known strategy for reducing the costs of pre-forming, transporting, and erecting wind turbines having rotor blades of increasing sizes is to manufacture the rotor blades in blade segments. As such, the blade segments may be assembled to form the rotor blade after, for example, the individual blade segments are transported to an erection location. For example, some rotor blades include either bonded or bolted joints. One such bolted joint includes a chord-wise extending pin securing a male shear web member or spar member within a female shear web member so as to join adjacent blade segments.

Various structural bonds may be used to join blade segments. First, elements of the structural ‘I’ beam, such as the skins of the shear web and the spar caps, may be used to join blade segments. Further, fasteners may be used to join longitudinal bulkheads and/or similar structures. Moreover, the outer skin and/or aerodynamic fairings may be joined using a shell-to-shell connection.

In addition, the outer skin typically forms the exterior aerodynamic airfoil shape of the rotor blade. In some turbine blades, the outer skin does not form a complete enclosure. More specifically, gaps and spaces may be left between the blade segments. As such, aerodynamic fairings can be used to cover the gaps and/or spaces between the blade segments to reduce form drag and interference drag. Such fairings may also improve the performance of the turbine blade. Moreover, the fairings can be joined together and/or to the outer skin using shell-to-shell connections.

A number of challenges may be involved in achieving the aforementioned connections, particularly with the outer skin bond. For example, the outer skin may be joined along scarf joints using adhesives, thermoplastics, and/or pre-preg film. Such methods often require internal and external pressures applied at the joint simultaneously. Such pressures maintain segments together and can allow for the formation of a strong bond at the joint.

The internal pressure, however, can be difficult to achieve and maintain on the mating surfaces during the bond process. Structural requirements must also be considered, such as, adequate transfer of the load (especially through 0° direction fibers). For example, the joint should be able to successfully transfer the load across the inner and outer skins on either side of the structural core. In addition, the surface bonds and sub-component bonds must be accurately aligned with smooth transitions to ensure suitable aerodynamic shape and performance.

Accordingly, the art is continuously seeking new and improved technologies for joining blade segments of rotor blades. More specifically, there is a need for a joint assembly for rotor blade segments that simplifies and expedites the assembly thereof.

### BRIEF DESCRIPTION

Aspects and advantages of the invention will be set forth in part in the following description, or may be obvious from the description, or may be learned through practice of the invention.

In one aspect, the present disclosure is directed to a method for joining rotor blade segments of a rotor blade. The method includes providing a first blade segment defining a concave cross-sectional shape having at least one internal flange. The method also includes providing a second blade segment having at least one external flange. Further, the method includes positioning the at least one internal flange of the first blade segment internal of the at least one external flange of the second blade segment at a joint. Moreover, the method includes placing at least one inflatable internal bladder within an inner cavity of the rotor blade at the joint. In addition, the method includes inflating the internal bladder(s) so as to provide internal pressure thereto so as to align the internal flange(s) with the external flange(s) and to maintain contact between the internal flange(s) and the external flange(s). Aligning the internal flange(s) and the external flange(s) may involve laterally or chord-wisely moving the internal flange(s) with respect to external flange(s) so as to align the first and second blade segment with respect to each other and/or so as to create a controlled aerodynamic surface of the rotor blade preferably via the external pressure. Thus, the method also includes securing the first and second blade segments together while maintaining the internal pressure via the at least one internal bladder.

In an embodiment, the method includes placing at least one core material within the first and second blade segments at the joint. In another embodiment, the internal flange(s) may include a first internal flange and an opposing, second internal flange. Similarly, the external flange(s) may include a first external flange and an opposing, second external flange. Further, the inflatable bladder(s) may include a first inflatable bladder and a second inflatable bladder.

Thus, in certain embodiments, the method may include positioning the first internal flange of the first blade segment adjacent to the first external flange of the second blade segment at a first joint, positioning the second internal flange of the first blade segment adjacent to the second external flange of the second blade segment at a second joint, placing the first inflatable bladder adjacent to the first internal flange of the first blade segment, and placing the second inflatable bladder adjacent to the second internal flange of the first blade segment.

In further embodiments, the core material(s) may include, for example, a plurality of core materials sized to fill an area between the first and second inflatable bladders. In additional embodiments, inflating the internal bladder(s) may include applying pressure to the first and second internal bladders such that the internal pressure is applied to each of the first and second internal flanges in opposing directions.

In several embodiments, the first and second internal bladders are sized such that the internal pressure is limited to the first and second joints. In an embodiment, inflating the internal bladder(s) may include applying pressure to the first and second internal bladders of about one (1) pounds per square inch (psi) to about three (3) psi.

In another embodiment, securing the first and second blade segments together may include bonding the first and second blade segments together via an adhesive or welding the first and second blade segments together.

In yet another embodiment, the method may include placing an external component adjacent an outer surface of the joint while securing the first and second blade segments together and also maintaining the internal pressure via the at least one internal bladder. For example, in an embodiment, the external component may be a fixed tooling surface or an external pressure source. Moreover, in an embodiment, the method may include applying heat to the outer surface of the joint simultaneously with supplying external pressure via the external pressure source so as to create a controlled aerodynamic surface of the rotor blade.

In particular embodiments, the method may include deflating the internal bladder(s) and removing the internal bladder(s) from within the rotor blade after securing the first and second blade segments together. In further embodiments, the method may also include removing the plurality of core materials from within the inner cavity of the rotor blade after securing the first and second blade segments together.

In additional embodiments, the first blade segment may include, for example, a leading edge bond cap, whereas the second blade segment may include a suction side surface and/or a pressure side surface.

In another aspect, the present disclosure is directed to a method for joining rotor blade segments of a rotor blade. The method includes providing a leading edge bond cap defining a concave cross-sectional shape having a first internal flange and an opposing, second internal flange. The method also includes providing at least one blade segment having a first external flange and an opposing, second external flange. Further, the method includes positioning the first internal flange adjacent to the first external flange at a first joint. Moreover, the method includes positioning the second internal flange adjacent to the second external flange at a second joint. In addition, the method includes placing a first inflatable bladder adjacent to the first internal flange. The method further includes placing a second inflatable bladder adjacent to the second internal flange. Also, the method includes placing at least one core material between the first and second inflatable bladders so as to fill an area between the first and second inflatable bladders. Thus, the method includes inflating the first and second internal bladders so as to provide internal pressure to each of the first and second internal flanges in opposing directions to align the first and second internal flanges with the first and second external flanges, respectively and to maintain contact between the first internal flange and the first external flange and the second internal flange and the second external flange, respectively. Aligning the internal flanges and the external flanges may involve laterally or chord-wisely moving the internal flanges with respect to external flanges so as to align the leading edge bond cap and the at least one blade segment with respect to each other and/or so as to create a controlled aerodynamic surface of the rotor blade preferably via the external pressure. Accordingly, the method includes securing the first and second blade segments together while maintaining the internal pressure via the first and second internal bladders.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of one of the rotor blades of FIG. 1;

FIG. 3 illustrates a cross-sectional view of one embodiment of a segmented rotor blade according to the present disclosure;

FIG. 4 illustrates a flow diagram of one embodiment of a method for joining rotor blade segments of a rotor blade according to the present disclosure;

FIG. 5 illustrates a cross-sectional view of one embodiment of a leading edge cap of a rotor blade having internal flanges according to the present disclosure;

FIG. 6 illustrates a cross-sectional view of one embodiment of rotor blade segments of a rotor blade being joined together in a mold according to the present disclosure;

FIG. 7 illustrates a cross-sectional view of one embodiment of the rotor blade segments of FIG. 6 being joined together in the mold with an inflatable bladder arranged between multiple core materials according to the present disclosure; and

FIG. 8 illustrates a cross-sectional view of another embodiment of rotor blade segments of a rotor blade being joined together with first and second inflatable bladders arranged with multiple core materials according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present subject matter is directed to a segmented rotor blade for a wind turbine and methods of manufacturing the same. For example, in one embodiment, the segmented rotor blade includes a first blade segment having a concave cross-sectional shape, a second blade segment, and a disposable, internal pressure source (e.g. such as an inflatable internal bladder). The first blade segment includes at least internal flange and the second blade segment includes at least one external flange. Thus, the internal and external flanges overlap at a joint that can be secured together. However, since the first concave blade segment includes an internal flange, conventional approaches of clamping the first and second blade segments together are not effective. Rather, because of the internal flanges, consolidation pressure must be applied from within the inner cavity of the rotor blade. Additionally, concave composite components tend to curl in on themselves due to shrinkage and need to be opened up to correct their geometry. Thus, the inflatable internal bladder(s) described herein are designed to achieve such objectives. In particular, inflating the bladder(s) inside of the rotor blade (e.g. within the leading edge bonding cap) can push the internal flange(s) open until the flange(s) reach a desired position (e.g. until the flange(s) is aligned with an external flange). Secondly, the pressure from the internal bladder(s) provides consolidation of the joint ensuring a successful bond.

It should be appreciated that, although the present subject matter will generally be described herein with reference to components of a wind turbine, the disclosed method may be generally used to bond any two or more composite parts along a joint.

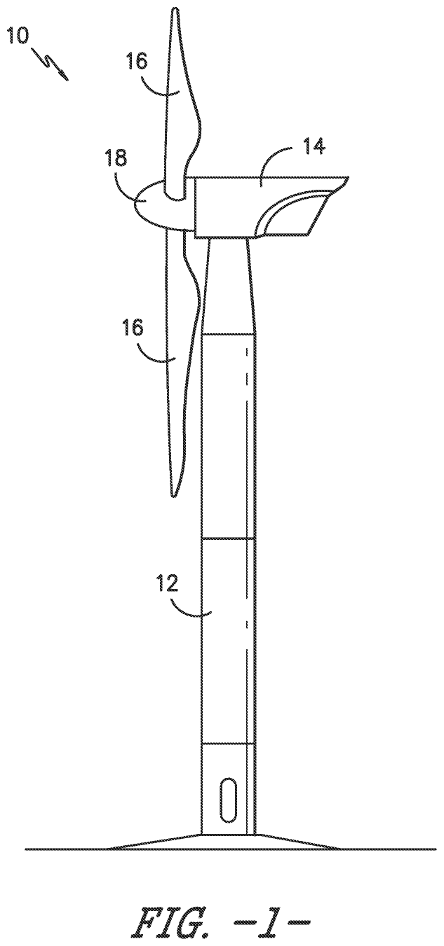

Referring now to the drawings, FIG. 1 illustrates a perspective view of one embodiment of a wind turbine 10 according to the present disclosure. As shown, the wind turbine 10 includes a tower 12 with a nacelle 14 mounted thereon. A plurality of rotor blades 16 are mounted to a rotor hub 18, which is in turn connected to a main flange that turns a main rotor shaft (not shown). The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

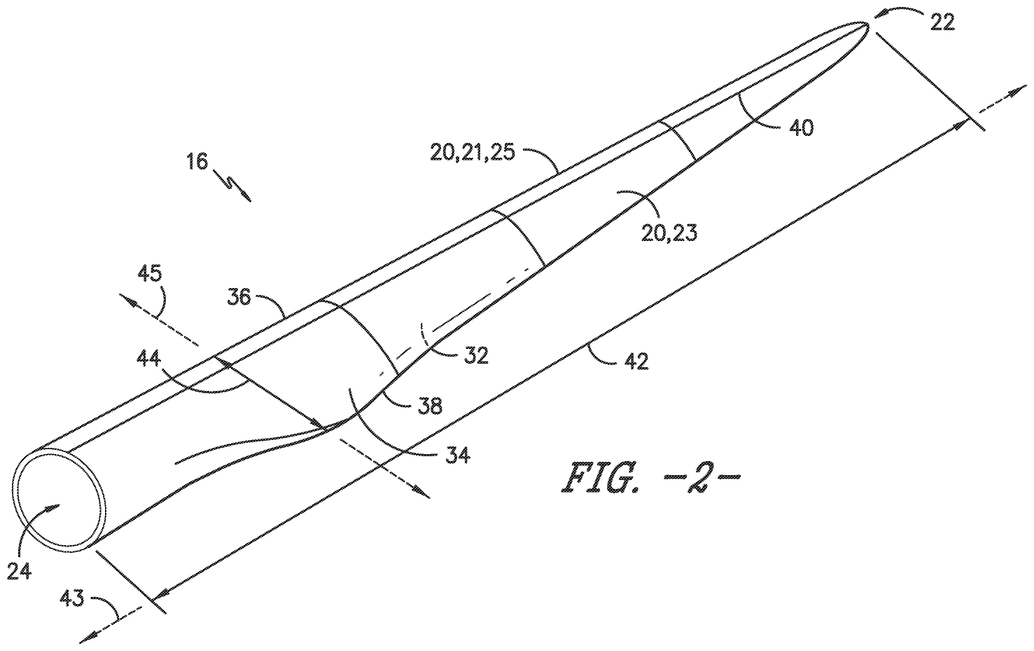

Referring now to FIG. 2, a perspective view of one embodiment of a rotor blade 16 of the wind turbine 10 of FIG. 1 according to the present disclosure is shown. As shown, the rotor blade 16 may include a plurality of individual blade segments 20 aligned in an end-to-end or side-by-side configuration from a blade tip 22 to a blade root 24. Further, as shown, each of the individual blade segments 20 may be uniquely configured so that the plurality of blade segments 20 define a complete rotor blade 16 having a designed aerodynamic profile, length, and other desired characteristics. For example, each of the blade segments 20 may have an aerodynamic contour that corresponds to the aerodynamic contour of adjacent blade segments 20. Thus, the aerodynamic contours of the blade segments 20 may form a continuous aerodynamic contour of the rotor blade 16. As such, the rotor blade 16 may include any suitable number of segments 20. For example, as shown, the rotor blade 16 includes three rotor blade segments 20. It should be understood, however, that the rotor blade 16 may have any suitable number of blade segments 20, such as less than three or more than three, such as four or more.

In general, the rotor blade 16 may include a pressure side 32 and a suction side 34 extending between a leading edge 36 and a trailing edge 38. Additionally, the rotor blade 16 may have a span 42 extending along a span-wise axis 43 and a chord 44 extending along a chord-wise axis 45. Further, as shown, the chord 44 may change throughout the span 42 of the rotor blade 16. Thus, a local chord may be defined at any span-wise location on the rotor blade 16 or any blade segment 20 thereof.

The rotor blade 16 may, in exemplary embodiments, be curved. Curving of the rotor blade 16 may entail bending the rotor blade 16 in a generally flapwise direction and/or in a generally edgewise direction. The flapwise direction is a direction substantially perpendicular to a transverse axis through a cross-section of the widest side of the rotor blade 16. Alternatively, the flapwise direction may be construed as the direction (or the opposite direction) in which the aerodynamic lift acts on the rotor blade 16. The edgewise direction is perpendicular to the flapwise direction. Flapwise curvature of the rotor blade 16 is also known as pre-bend, while edgewise curvature is also known as sweep. Thus, a curved rotor blade 16 may be pre-bent and/or swept. Curving may enable the rotor blade 16 to better withstand flapwise and edgewise loads during operation of the wind turbine 10, and may further provide clearance for the rotor blade 16 from the tower 12 during operation of the wind turbine 10.

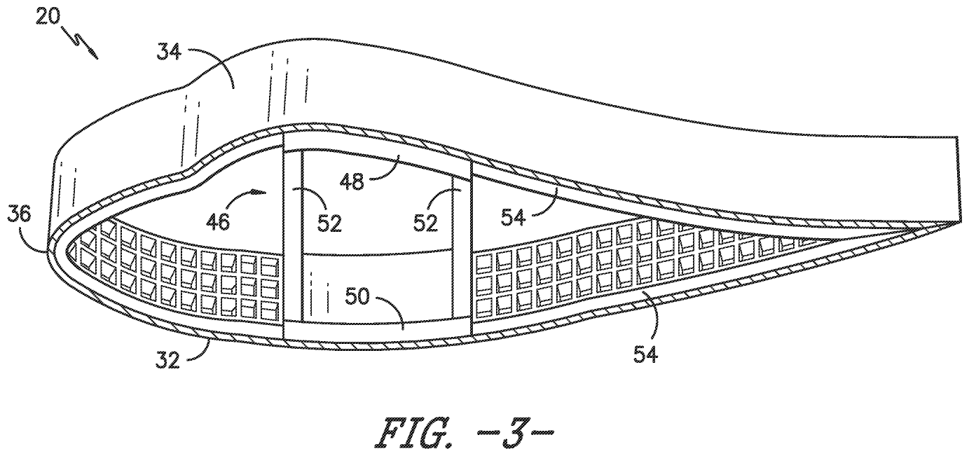

In exemplary embodiments, and as discussed in detail below, the rotor blade segments 20 may be joined together through a joint 40 as further described herein below. Furthermore, as shown in FIGS. 2 and 3, the blade segments 20 may include, at least, a first blade segment 21 and a second blade segment 23. Further, as shown, the first blade segment 21 may include, for example, a leading edge bond cap 25. Moreover, as shown, the second blade segment 23 may include a pressure side surface 32 or a suction side surface 34. Further, as shown in FIG. 3, the rotor blade 16 may include one or more structural components, such as a box beam structure 46 that includes spar caps 48, 50 on either or both of the pressure or suction sides 32, 34 of the rotor blade 16. In addition, the rotor blade 16 may also include one or more shear webs 52 extending between the spar caps 48, 50. It should be understood that although a box beam configuration is shown, any other suitable structural configuration may also be included in the rotor blade 16. In addition, as shown, the pressure side surface 32 and/or the suction side surface 34 may be reinforced with a grid structure 54.

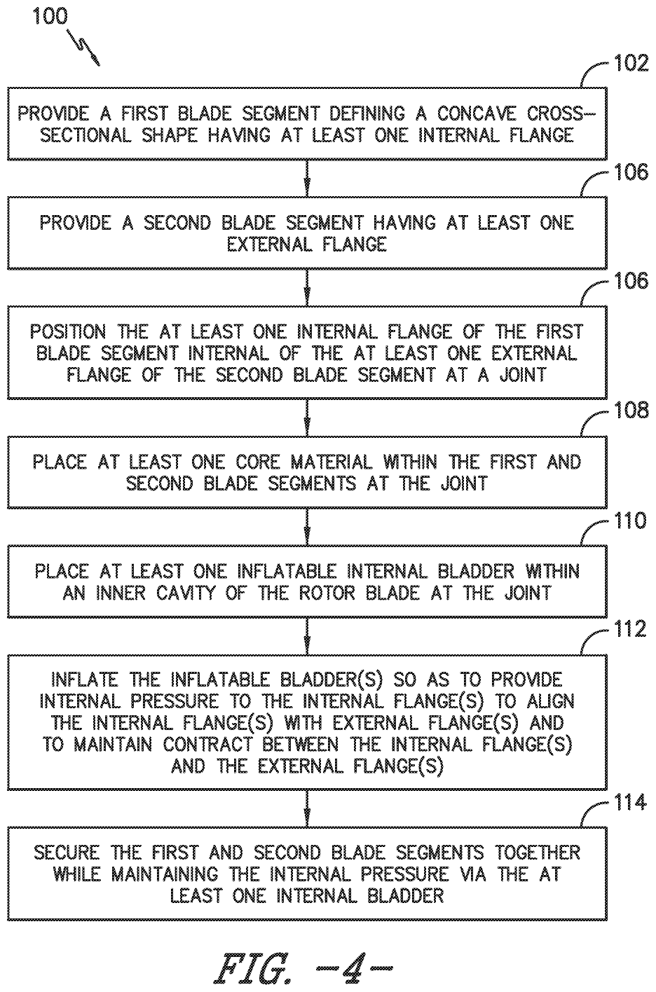

Referring now to FIG. 4, the present disclosure is also directed to methods for joining the rotor blade segments 20 of the rotor blade 16. For example, as shown in FIG. 4, a flow diagram of one embodiment of a method 100 for joining rotor blade segments 20 of the rotor blade 16 is illustrated. In general, the method 100 is described herein as relating to joining wind turbine rotor blades. However, it should be appreciated that the disclosed method 100 may be implemented using any other suitable rotor blades now known or later developed in the art and is also not limited to wind turbines. In addition, although FIG. 9 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

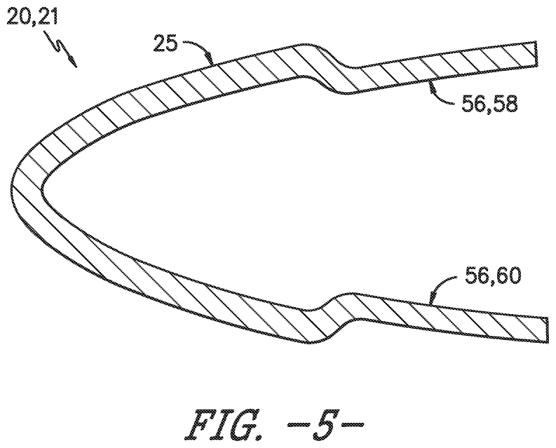

As shown at (102), the method 100 includes providing a first blade segment 21 defining a concave cross-sectional shape having at least one internal flange 56. For example, as shown in FIG. 5, the first blade segment 21 may include, for example, a leading edge bond cap 25. Further, as shown, the internal flange(s) 56 may include a first internal flange 58 and an opposing, second internal flange 60.

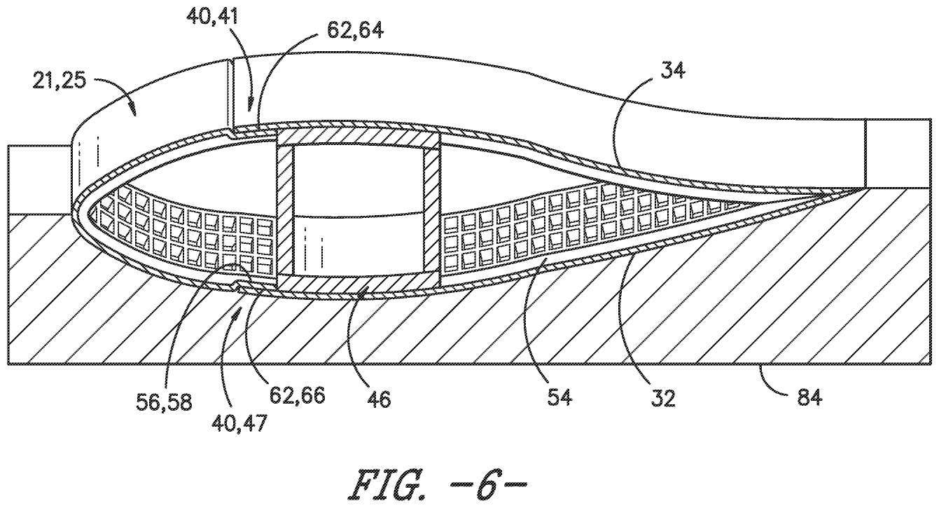

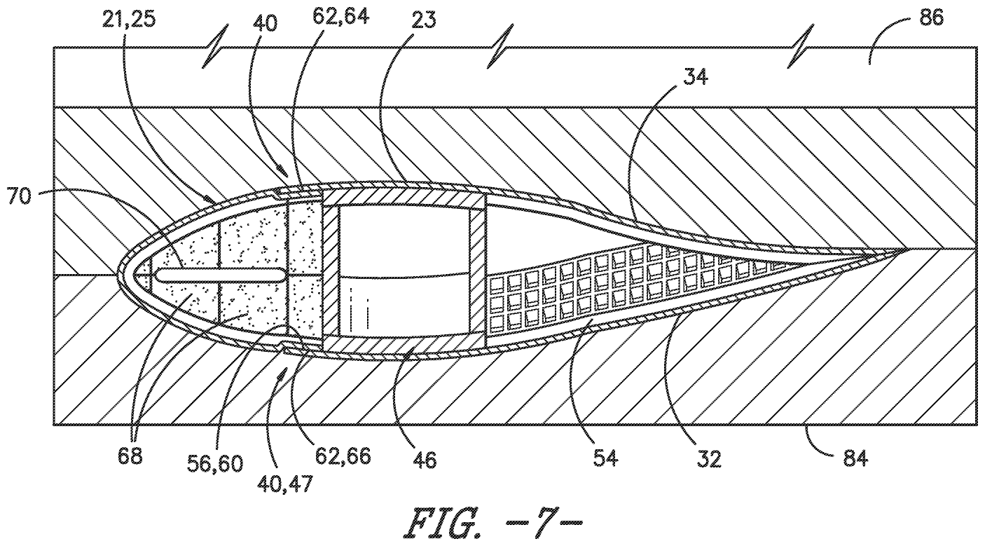

Thus, referring back to FIG. 4, as shown at (104), the method 100 includes providing a second blade segment 23 having at least one external flange 62. For example, in certain embodiments, as shown in FIGS. 6 and 7, the second blade segment 23 may include the suction side surface and/or the pressure side surface. Further, as shown, the external flange(s) 62 may include a first external flange 64 and an opposing, second external flange 66.

For example, as shown in FIG. 6, the first blade segment 21, the box beam structure 46, and the second blade segment 23 may be first placed atop a first mold 84. Accordingly, as shown at (106) of FIG. 4, the method 100 also includes positioning the internal flange(s) 58, 60 of the first blade segment 21 internal of the external flange(s) 64, 66 of the second blade segment 23 at the joint(s) 40. More specifically, as shown in FIG. 6, the method 100 may include positioning the first internal flange 58 of the first blade segment 21 adjacent to the first external flange 64 of the second blade segment 21 at a first joint 41, positioning the second internal flange 60 of the first blade segment 21 adjacent to the second external flange 66 of the second blade segment 23 at a second joint 43.

In addition, as shown at (108), the method 100 may include placing at least one core material 68 within the first and second blade segments 21, 23 at the joint 40. For example, as shown in FIG. 7, the core material(s) 68 may be placed within a cavity defined by the concave shape of the first blade segment 21. In such embodiments, the core material(s) 68 described herein may include, for example, foam bulkheads, balsa wood bulkheads, and/or any other suitable core material.

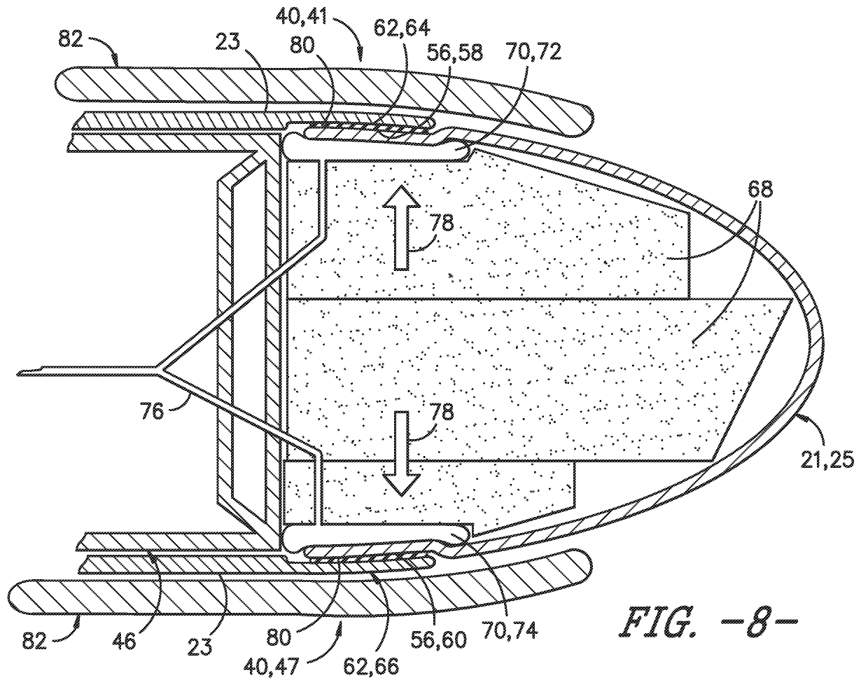

In addition, as shown at (110) of FIG. 4, the method 100 includes placing at least one inflatable internal bladder 70 within an inner cavity of the rotor blade 16 at the joint 40. For example, as shown in FIG. 7, the inflatable bladder 70 may be placed between one or more of the core materials 68 at the joint(s) 40. Thus, as shown in the embodiment of FIG. 7, the core material(s) 68 may be arranged around the inflatable bladder 70 to form an internal pressure source. Alternatively, as shown in FIG. 8, multiple core materials 68 may be arranged and sized to fill an area between the first and second inflatable bladders 72, 74 described herein below.

The internal bladder(s) 70 of the present disclosure may be formed from plastic or aerospace-type films. As such, the core material(s) 68 may position and orient the internal bladder(s) 70 in proximity to its desired location. Such placement can remove the necessity of using high pressure to inflate the internal bladder(s) 70, allowing a thinner walled, lighter bladder. Such internal bladder(s) 70 can be manufactured cheaper than other bladders known in the art, such as those made from silicon. As such, the internal bladder(s) 70 may be left inside the rotor blade 16 where it may be cost prohibitive to leave bladders made from materials such as silicon.

In alternative embodiments, as shown in FIG. 8, the inflatable bladder(s) 70 may include a first inflatable bladder 72 and a second inflatable bladder 74. In such embodiments, as shown, the first inflatable bladder 72 may be positioned adjacent to the first internal flange 58, whereas the second inflatable bladder 74 may be positioned adjacent to the second internal flange 60, with one or more core materials 68 arranged therebetween. Thus, in several embodiments, the various internal bladders 70 described herein may be sized such that the internal pressure is limited to the first and second joints 41, 47. More specifically, in such embodiments, as shown in FIG. 8, the method 100 may include placing the first inflatable bladder 72 adjacent to the first internal flange 58 of the first blade segment and placing the second inflatable bladder 74 adjacent to the second internal flange 60 of the first blade segment 23. As such, the core material(s) 68 and/or the inflatable bladder(s) 70 can provide internal pressure to the first and second internal flanges 58, 60 at the respective first and second joints 41, 47.

In particular, as shown in FIG. 7, once the various rotor blade components are placed atop the first mold 84, another second mold 86 can be placed atop the first mold 84 such that the blade components are held in place via the first and second molds 82, 84. Accordingly, and referring back to FIG. 4, as shown at (112), the method 100 includes inflating the inflatable bladder(s) 70 so as to provide internal pressure to the internal flange(s) 56 to align the internal flange(s) 56 with the external flange(s) 62 and to maintain contact between the internal flange(s) 56 and the external flange(s) 62.

More specifically, the core material(s) 68 can be used to orient and secure the inflatable bladder(s) 70 for a desirable internal pressure distribution. For example, the shape of the core material(s) 68 can help to place the inflatable bladder(s) 70 in a desirable location to supply internal pressure to the joint(s) 40. Thus, in an embodiment, the internal bladder(s) 70 may be inflated by applying pressure to each the first and second internal bladders 72, 74 such that the internal pressure is applied to each of the first and second internal flanges 58, 60, respectively, in opposing directions (as indicated by the arrows 78 in FIG. 8). Furthermore, in an embodiment, the method 100 may include inflating the internal bladder 70 to apply pressure thereto ranging from about one (1) to about fifteen (15) pounds per square inch (psi). In another embodiment, pressure may be applied to the inflatable bladder(s) 70 ranging from about one (1) to about (3) psi, such as about two (2) to about three (3) psi.

Referring particularly to FIG. 8, pressure may be supplied to the inflatable bladder(s) 70 via one or more tubes 76 supplying a pressurized fluid, such as air. In certain embodiments, the tube(s) 76 may be approximately a quarter inch in diameter and be fed to the inflatable bladder(s) 70 through a small corresponding hole in the turbine blade 16 and/or core material(s) 68. Once the blade segments 21, 23 are secured together, the tube(s) 76 may be cut and removed or left in place.

Referring back to FIG. 4, as shown at (114), the method 100 includes securing the first and second blade segments 21, 23 together while maintaining the internal pressure via the internal bladder(s) 70. For example, in an embodiment, securing the first and second blade segments 21, 23 together may include bonding the first and second blade segments together 21, 23, e.g. via an adhesive 80 (FIG. 8). In addition or in alternative embodiments, securing the first and second blade segments 21, 23 together may include welding the first and second blade segments 21, 23 together, e.g. via thermoplastic welding when the first and second blade segments 21, 23 are constructed of a thermoplastic material.

Thus, in certain embodiments, the method 100 may include supplying external pressure at an outer surface of the joint(s) 41, 47 while securing the first and second blade segments 21, 23 together and also maintaining the internal pressure via the internal bladder(s) 70. Alternatively, the method 100 may include placing a fixed tooling surface adjacent to the joint, e.g. to provide a stop or guide. Moreover, in an embodiment, the method 100 may include applying heat to the outer surface of the joint(s) 41, 47 simultaneously with supplying external pressure via the external pressure source so as to create a controlled aerodynamic surface of the rotor blade 16. For example, referring particularly to FIG. 8, one or more heat or pressure source(s) 82 may be positioned adjacent to at least one of the blade segments 21, 23. The heat or pressure source(s) 82 may include an external heating mat or convection heating of the joints 41, 47. In further embodiments, the heat or pressure source(s) 82 may include a heating mat including conducting coils with a specified resistance and current designed to heat the thermoplastic material(s) of the blade segments 21, 23 to a desired temperature at a desired rate.

The thermoplastic material as described herein generally encompasses a plastic material or polymer that is reversible in nature. For example, thermoplastic materials typically become pliable or moldable when heated to a certain temperature and solidify upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, aliphatic polyurethane, or any other suitable amorphous thermoplastic material. In addition, exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material.

In particular embodiments, the method 100 may also include deflating the internal bladder(s) and removing the internal bladder(s) from within the rotor blade 16 after securing the first and second blade segments 21, 23 together. In further embodiments, the method 100 may also include removing the plurality of core materials 68 from within the inner cavity of the rotor blade 16 after securing the first and second blade segments 21, 23 together. For example, as shown in FIG. 3, a cross-section of a completed rotor blade 16 is illustrated with the core materials 68 and bladders 70 removed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

The following is a list of items disclosing a number of exemplary embodiments:
1. A method for joining rotor blade segments of a rotor blade, the method comprising:
providing a first blade segment defining a concave cross-sectional shape having at least one internal flange;
providing a second blade segment having at least one external flange;
positioning the at least one internal flange of the first blade segment internal of the at least one external flange of the second blade segment at a joint;
placing at least one inflatable internal bladder within an inner cavity of the rotor blade at the joint;
inflating the at least one internal bladder so as to provide internal pressure thereto so as to align the at least one internal flange with the at least one external flange and to maintain contact between the at least one internal flange and the at least one external flange; and,
securing the first and second blade segments together while maintaining the internal pressure via the at least one internal bladder.
2. The method of item 1, further comprising placing at least one core material within the first and second blade segments at the joint.
3. The method of item 2, wherein the least one internal flange comprises a first internal flange and an opposing, second internal flange, the least one external flange comprises a first external flange and an opposing, second external flange, and the at least one inflatable bladder comprises a first inflatable bladder and a second inflatable bladder.
4. The method of item 3, the method further comprising:
positioning the first internal flange of the first blade segment adjacent to the first external flange of the second blade segment at a first joint;
positioning the second internal flange of the first blade segment adjacent to the second external flange of the second blade segment at a second joint;
placing the first inflatable bladder adjacent to the first internal flange of the first blade segment; and
placing the second inflatable bladder adjacent to the second internal flange of the first blade segment.
5. The method of item 4, wherein the at least one core material comprises a plurality of core materials sized to fill an area between the first and second inflatable bladders.
6. The method of item 5, wherein inflating the at least one internal bladder further comprises:
applying pressure to the first and second internal bladders such that the internal pressure is applied to each of the first and second internal flanges in opposing directions.
7. The method of item 5, wherein the first and second internal bladders are sized such that the internal pressure is limited to the first and second joints.
8. The method of item 5, wherein inflating the at least one internal bladder further comprises:
applying pressure to the first and second internal bladders of about one (1) pounds per square inch (psi) to about three (3) psi.
9. The method of item 1, wherein securing the first and second blade segments together further comprises at least one of bonding the first and second blade segments together via an adhesive or welding the first and second blade segments together.
10. The method of item 1, further comprising placing an external component adjacent an outer surface of the joint while securing the first and second blade segments together and also maintaining the internal pressure via the at least one internal bladder, wherein the external component comprises a fixed tooling surface or an external pressure source.
11. The method of item 10, further comprising applying heat to the outer surface of the joint simultaneously with supplying external pressure via the external pressure source so as to create a controlled aerodynamic surface of the rotor blade.
12. The method of item 1, further comprising deflating the at least one internal bladder and removing the at least one internal bladder from within the rotor blade after securing the first and second blade segments together.
13. The method of item 1, further comprising removing the plurality of core materials from within the inner cavity of the rotor blade after securing the first and second blade segments together.
14. The method of item 1, wherein the first blade segment comprises a leading edge bond cap and the second blade segment comprises at least one of a suction side surface or a pressure side surface.
15. A method for joining rotor blade segments of a rotor blade, the method comprising:
providing a leading edge bond cap defining a concave cross-sectional shape having a first internal flange and an opposing, second internal flange;
providing at least one blade segment having a first external flange and an opposing, second external flange;
positioning the first internal flange adjacent to the first external flange at a first joint;
positioning the second internal flange adjacent to the second external flange at a second joint;
placing a first inflatable bladder adjacent to the first internal flange;
placing a second inflatable bladder adjacent to the second internal flange;
placing at least one core material between the first and second inflatable bladders so as to fill an area between the first and second inflatable bladders;
inflating the first and second internal bladders so as to provide internal pressure to each of the first and second internal flanges in opposing directions to align the first and second internal flanges with the first and second external flanges, respectively and to maintain contact between the first internal flange and the first external flange and the second internal flange and the second external flange, respectively; and
securing the first and second blade segments together while maintaining the internal pressure via the first and second internal bladders.
16. The method of item 15, wherein the first and second internal bladders are sized such that the internal pressure is limited to the first and second joints.
17. The method of item 15, wherein inflating the first and second internal bladder further comprises:
applying pressure to the first and second internal bladders of about one (1) pounds per square inch (psi) to about three (3) psi.
18. The method of item 15, wherein securing the first and second blade segments together further comprises at least one of bonding the first and second blade segments together via an adhesive or welding the first and second blade segments together.
19. The method of item 15, further comprising placing an external component adjacent an outer surface of the joint while securing the first and second blade segments together and also maintaining the internal pressure via the at least one internal bladder, wherein the external component comprises a fixed tooling surface or an external pressure source.
20. The method of item 19, further comprising applying heat to the outer surface of the joint simultaneously with supplying external pressure via the external pressure source so as to create a controlled aerodynamic surface of the rotor blade.

1. A method for joining rotor blade segments of a rotor blade,
the method comprising:
providing a first blade segment defining a concave cross-sectional shape having at least one internal flange;
providing a second blade segment having at least one external flange;
positioning the at least one internal flange of the first blade segment internal of the at least one external flange of the second blade segment at a joint;
placing at least one inflatable internal bladder within an inner cavity of the rotor blade at the joint;
inflating the at least one internal bladder so as to provide internal pressure thereto so as to align the at least one internal flange with the at least one external flange and to maintain contact between the at least one internal flange and the at least one external flange; and
securing the first and second blade segments together while maintaining the internal pressure via the at least one internal bladder.

2. The method of claim 1, wherein aligning the at least one internal flange and the at least one external flange involves laterally or chord-wisely moving the at least one internal flange with respect to at least one external flange so as to align the first and second blade segment with respect to each other and/or so as to create a controlled aerodynamic surface of the rotor blade preferably via external pressure or an external component.

3. The method of claim 1, further comprising placing at least one core material within the first and second blade segments at the joint.

4. The method of claim 3, wherein the at least one core material comprises a plurality of core materials sized to fill an area between the first and second inflatable bladders.

5. The method of claim 3, further comprising removing the at least one core material from within the inner cavity of the rotor blade after securing the first and second blade segments together.

6. The method of claim 1, wherein the least one internal flange comprises a first internal flange and an opposing, second internal flange, the least one external flange comprises a first external flange and an opposing, second external flange, and the at least one inflatable bladder comprises a first inflatable bladder and a second inflatable bladder.

7. The method of claim 6, the method further comprising:
positioning the first internal flange of the first blade segment adjacent to the first external flange of the second blade segment at a first joint;
positioning the second internal flange of the first blade segment adjacent to the second external flange of the second blade segment at a second joint;
placing the first inflatable bladder adjacent to the first internal flange of the first blade segment; and
placing the second inflatable bladder adjacent to the second internal flange of the first blade segment.

8. The method of claim 7, wherein inflating the at least one internal bladder further comprises:
applying pressure to the first and second internal bladders such that the internal pressure is applied to each of the first and second internal flanges in opposing directions.

9. The method of claim 7, wherein the first and second internal bladders are sized such that the internal pressure is limited to the first and second joints.

10. (canceled)

11. The method of claim 1, wherein securing the first and second blade segments together further comprises at least one of bonding the first and second blade segments together via an adhesive or welding the first and second blade segments together.

12. The method of claim 1, further comprising placing an external component adjacent an outer surface of the joint while securing the first and second blade segments together and also maintaining the internal pressure via the at least one internal bladder, wherein the external component comprises a fixed tooling surface or an external pressure source.

13. The method of claim 1, further comprising applying heat to the outer surface of the joint simultaneously with supplying external pressure via the external pressure source so as to create a controlled aerodynamic surface of the rotor blade.

14. The method of claim 1, further comprising deflating the at least one internal bladder and removing the at least one internal bladder from within the rotor blade after securing the first and second blade segments together.

15. The method of claim 1, wherein the first blade segment comprises a leading edge bond cap and the second blade segment comprises at least one of a suction side surface or a pressure side surface.

16. A method for joining rotor blade segments of a rotor blade, the method comprising:
providing a leading edge bond cap defining a concave cross-sectional shape having a first internal flange and an opposing, second internal flange;
providing at least one blade segment having a first external flange and an opposing, second external flange;
positioning the first internal flange adjacent to the first external flange at a first joint;
positioning the second internal flange adjacent to the second external flange at a second joint;
placing a first inflatable bladder adjacent to the first internal flange;
placing a second inflatable bladder adjacent to the second internal flange;
placing at least one core material between the first and second inflatable bladders so as to fill an area between the first and second inflatable bladders;
inflating the first and second internal bladders so as to provide internal pressure to each of the first and second internal flanges in opposing directions to align the first and second internal flanges with the first and second external flanges, respectively and to maintain contact between the first internal flange and the first external flange and the second internal flange and the second external flange, respectively; and
securing the leading edge bond cap and the at least one blade segment together while maintaining the internal pressure via the first and second internal bladders.

17. The method of claim 16, wherein aligning the internal flanges and the external flanges involve laterally or chord-wisely moving the internal flanges with respect to external flanges so as to align the leading edge bond cap and the at least one blade segment with respect to each other and/or so as to create a controlled aerodynamic surface of the rotor blade preferably via an external pressure or an external component.

18. The method of claim 16, wherein the first and second internal bladders are sized such that the internal pressure is limited to the first and second joints.

19. (canceled)

20. The method of claim 16, wherein securing the leading edge bond cap and the at least one blade segment together further comprises at least one of bonding the leading edge bond cap and the at least one blade segment together via an adhesive or welding the leading edge bond cap and the at least one blade segment together.

21. The method of claim 16, further comprising placing an external component adjacent an outer surface of the joint while securing the leading edge bond cap and the at least one blade segment together and also maintaining the internal pressure via the at least one internal bladder, wherein the external component comprises a fixed tooling surface or an external pressure source.

22. The method of claim 21, further comprising applying heat to the outer surface of the joint simultaneously with supplying external pressure via the external pressure source so as to create a controlled aerodynamic surface of the rotor blade.

23-24. (canceled)
